(19) United States
(12) Patent Application Publication
(10) Pub. No.: US 2006/0031124 A1
(43) Pub. Date: Feb. 9, 2006

(54) Collaborative logistics information exchange method and apparatus

(75) Inventor: Robert Bruce Galbraith, Simpsonville, SC (US)

Correspondence Address: DORITY & MANNING, P.A., POST OFFICE BOX 1449, GREENVILLE, SC, 29602-1449, US

(73) Assignee: Liberty Logistics Inc.

(21) Appl. No.: 11/059,281

(22) Filed: Feb. 16, 2005

Related U.S. Application Data
(63) Continuation-in-part of application No. 10/914,612, filed on Aug. 9, 2004.

(51) Int. Cl. G06Q 30/00

(52) U.S. Cl. 705/26

(57) ABSTRACT

Disclosed is an apparatus and methodology for collaborative logistics information exchange that permits the entry, storage, retrieval and viewing of data pertinent to the transportation of freight loads or product coordinated through a logistics provider and/or his agent(s). Information exchange may be conducted over a local or wide area network or the Internet substantially in real time and may include capabilities of storing and transmitting images of selected paper documents, conducting instant messaging sessions and attaching load relevant electronic notes to selected stored information. Proof of product delivery may be establish through the provision of specially formatted labels printed and attached to selected paper documents coupled with the electronic transmission of corresponding data to the logistics provider.

### CROSS REFERENCE TO RELATED APPLICATIONS

This application is a Continuation-In-Part of previously filed U.S. patent application Ser. No. 10/914,612, entitled “Collaborative Logistics Information Exchange Environment And System,” with the same inventor as present, filed Aug. 9, 2004 and U.S. Provisional Patent Application Ser. No. 60/493,481, entitled “Collaborative Logistics Information Exchange Environment And System” filed Aug. 8, 2003, both of which are fully incorporated herein by reference for all purposes.

### FIELD OF THE INVENTION

The present subject matter relates to methods and apparatus for the exchange of information, especially proof of delivery information, from logistic providers and their agents to their clients. The present subject matter also pertains to methods for permitting access to such information, possibly by way of the Internet.

### BACKGROUND OF THE INVENTION

Logistics providers arrange for the transportation of products or goods for their clients, possibly manufacturers, from one location to another. Logistics providers may correspond to individuals or companies and may be described as logistics providers, logistics brokers, third party logistics providers (3PL), or direct providers. The technology herein described is directed to all such entities. The departure point for such transportation may be a manufacturing facility, warehouse or other facility, while the destination may be a distribution center, retail sales establishment, or other location. At present logistics providers expend a great deal of effort maintaining computerized databases permitting information exchange between the provider and his or her client(s). By maintaining such computerized databases, the logistics provider is able to supply his clients with limited information regarding freight loads or shipments that the client has committed to the provider to move for the client. Although the databases are computerized, data entry is a manual process and the entire process is paper driven.

These computerized databases and systems, while useful, are limited in that they do not currently provide any mechanism to allow a client to track their freight loads as they are picked up and/or delivered. At present, clients must rely on the provider to furnish this information either by paper documents in the form of mailed or faxed documents, by telephone, or through some other form of direct communication. Also the paper work that is associated with these loads (Bill of Lading and Pick and Delivery) must be mailed or faxed before clients can invoice the load to their customers.

In addition to a lack of load tracking capability, there are a number of other areas of interest to both the logistics provider and clients that are not presently being addressed. This is due in part to the inadequacies of the computer systems currently being used and to the fact that existing systems have not utilized wide area or globally available communications systems such as wide area networks, Intranets, or the Internet to provide information exchange between providers and their clients. Were such wide area communications capabilities available, logistics providers and their clients might be spared from investing excessive of time, energy, and financial resources in building and maintaining information exchange interfaces or an Internet presence.

Logistics based systems are, in general, known, however the known systems are limited in that they provide only a provider to client relationship. Moreover known systems impose burdens on Logistics Providers and/or their agents in that they do not permit real time information or real time documentation so that clients may know their freight load locations or that such loads have been correctly delivered.

While various implementations of logistics information exchange systems have been developed, no design has emerged that generally encompasses all of the desired characteristics as hereafter presented in accordance with the subject technology.

### SUMMARY OF THE INVENTION

In view of the recognized features encountered in the prior art and addressed by the present subject matter, an improved methodology and system is provided for communicating logistic freight load information between Logistics Providers and/or their agents and their clients. The methodology and system in accordance with the present technology may be provided as a subscription, private, or public service and may be configured for use in association with a local area network (LAN), a wide area network (WAN), an Intranet or the globally accessible Internet.

In accordance with one aspect of certain embodiments of the present technology a methodology is provided for authorizing selected individuals to be given access to certain types of logistic load information that may be proprietary or confidential in nature. Such authorization permits control over issues including confidentiality of information, intrusion by idle curiosity seekers and the general public and approach by unwanted business solicitors.

In accordance with another aspect of certain embodiments of the present technology, methodologies are provided to insure that individuals having unethical or criminal motives would not be allowed to use logistic freight load information to their wrongful advantage.

In accordance with yet another aspect of certain embodiments of the present technology methodologies are provided for establishing necessary criteria for qualifying a client to receive freight logistic load information by first establishing a business relationship between a logistics provider and a client.

In accordance with a further aspect of certain embodiments of the present technology a prospective client may be permitted to view certain other client's information if it is appropriate for the provider to provide a prospective client with this information and the provider has obtained the approval of the client, either directly or inferentially.

In accordance with yet a further aspect of certain embodiments of the present technology a methodology and system is provided to allow clients to view all paper work pertaining to a freight load by freight load basis including allowing the client to view the signed Bill of Lading, pick paper work, and delivery paper work and, in turn, print out, and invoice their customer.

In accordance with yet still a further aspect of certain embodiments of the present technology a methodology and system is provided to allow clients to view an activity listing of current undelivered loads and their expected time of pickup and delivery, as well as an activity listing of delivered freight loads that provides the time and date of delivery as well as online documentation for each freight load delivered the same day it is delivered. Online availability of such information relieves the provider from having to manually provide such valuable information to his clients.

In accordance with yet still another aspect of certain embodiments of the present technology a methodology and associated system elements are provided to establish evidence for clients of actual product delivery to intended destinations.

Additional aspects of the present technology are set forth in, or will be apparent to, those of ordinary skill in the art from the detailed description herein. Also, it should be further appreciated that modifications and variations to the specifically illustrated, referred and discussed features and elements hereof may be practiced in various embodiments and uses of the invention without departing from the spirit and scope of the subject matter. Variations may include, but are not limited to, substitution of equivalent means, features, or steps for those illustrated, referenced, or discussed, and the functional, operational, or positional reversal of various parts, features, steps, or the like.

Still further, it is to be understood that different embodiments, as well as different presently preferred embodiments, of the present subject matter may include various combinations or configurations of presently disclosed features, steps, or elements, or their equivalents (including combinations of features, parts, or steps or configurations thereof not expressly shown in the figures or stated in the detailed description of such figures).

Additional embodiments of the present subject matter, not necessarily expressed in the summarized section, may include and incorporate various combinations of aspects of features, components, or steps referenced in the summarized objects above, and/or other features, components, or steps as otherwise discussed in this application. Those of ordinary skill in the art will better appreciate the features and aspects of such embodiments, and others, upon review of the remainder of the specification.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 is a Block Diagram flowchart view of a collaborative logistics information exchange usable over the Internet and an Intranet in accordance with the present technology;

FIG. 2 is a Block Diagram flowchart illustrating the manual entry process of freight load data into the database of the collaborative logistics information exchange;

FIG. 3 is a Block Diagram flowchart of the client website of the collaborative logistics information exchange;

FIG. 4 is a Block Diagram flowchart of the carrier website of the collaborative logistics information exchange;

FIG. 5 is a network flowchart of the providers internal LAN of the collaborative logistics information exchange; and

FIG. 6 is a network flowchart of the providers WAN of the collaborative logistics information exchange.

Repeat use of reference characters throughout the present specification and appended drawings is intended to represent same or analogous features or elements of the invention.

### DETAILED DESCRIPTION OF THE PREFERRED EMBODIMENTS

As discussed in the Summary of the Invention section, the present subject matter is particularly concerned with collaborative logistics information exchange methodologies and systems configured to permit the exchange of information between involved parties relating to aspects concerning the verifiable transportation and delivery of product from one location to another.

Selected combinations of aspects of the disclosed technology correspond to a plurality of different embodiments of the present invention. It should be noted that each of the exemplary embodiments presented and discussed herein should not insinuate limitations of the present subject matter. Features or steps illustrated or described as part of one embodiment may be used in combination with aspects of another embodiment to yield yet further embodiments. Additionally, certain features may be interchanged with similar devices or features not expressly mentioned which perform the same or similar function.

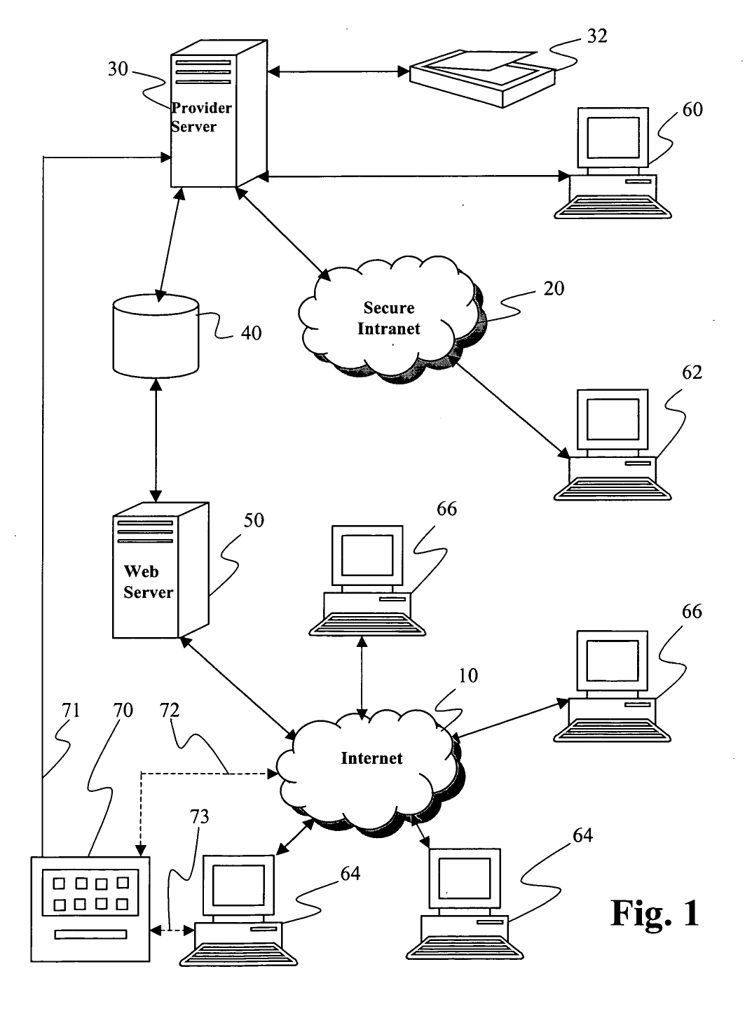

Reference will now be made in detail to the presently preferred embodiments of the present technology referring on occasion to all of the drawings and in particular now to FIG. 1 wherein is illustrated a block diagram system overview of a collaborative logistics information exchange in accordance with the present technology. A network coupling the various components of the collaborative logistics information exchange may include the Internet 10 as well as a Local Area Network (LAN) 20, sometimes also referred to as an Intranet. Only a small representation of the Internet 10 is shown, as it is well understood that the Internet 10 is quite expansive and expandable.

Provider server 30 is electronically connected to the Internet 10 or other wide area network by way of database 40 and Web Server 50. Provider server 30 is configured to communicate with other computers and peripheral devices including, for example, facsimile or scanner device 32, that may also be connected to the network comprising the collaborative logistics information exchange, as is well understood in the art.

Provider server 30 is configured for access to database 40, which it updates and maintains as new, relevant information is received by way of the collaborative logistics information exchange network. Database maintenance, updates and additions and/or information retrieval may be carried out by a number of users connected to the network by way of user workstations. These workstations may include a Provider workstation 60, one or more authorized agent's workstation 62, one or more client workstations 64, 64 and one or more carrier workstations 66, 66. Selected of the various workstations are permitted access to certain of the information fields or files that may be stored in the database 40 or which are compiled by the provider server 30 during its operation. As should be apparent to those of ordinary skill in the art, any number of these types of users by way of appropriate workstations may be granted controlled access to the system comprising the collaborative logistics information exchange network.

Normally, Clients and authorized carriers must be under contract with the provider and/or his agent(s) in order to be permitted access to the system. Listing the clients and carriers on a register or table of clients and carriers in database 40 may be reflective of granting select clients and carriers access to the collaborative logistics information exchange network. Other types of users, for example data entry, computer system analysts, and other types of software specialists may also be granted specialized access capabilities as needed to enter data and to service the collaborative logistics information exchange system, as is well known in the computer arts although not specifically described herein. As should be apparent to those of ordinary skill in the pertinent art, the number of various users of the collaborative logistics information exchange network may be multiplied as necessary and required to accommodate overall system and network requirements.

Referring again to FIG. 1, a generally block diagram has been illustrated showing features that govern overall system operation for any given activity. It is noted that all of the various figures and flowcharts provided herein are supplied for general information purposes sufficient to provide an enabling disclosure to one skilled in the computer programming and system arts, but are not necessarily discussed in detail unless it is to illustrate a particular feature of the system. Some of the figures will provide greater detail of the system features and operation. A review of the figures and flowcharts is intended to disclose an exemplary methodology in which the various features and capabilities of the system may be provided. Obviously, other ways may become apparent to those having ordinary skill in the programming arts upon review of the present disclosure.

FIG. 1 illustrates an exemplary provider intranet site wherein data regarding various freight loads is entered into the collaborative logistics information exchange network. After information is received from contracted clients, relevant data is entered via a provider workstation 60 or agent workstation 62 into the system based on a menu selection made by the workstation user.

An additional feature of the present technology may be seen in FIG. 1 with reference to Proof of Delivery (POD) device 70. POD 70, as will be more fully discussed throughout the remainder of the present disclosure, comprises a communication device combined or associated with a printer that may be physically located at one or more client sites. More specifically, POD 70 is intended to be located at a product delivery location and corresponds to a mechanism providing electronic and physical evidence whereby proof of product delivery may be established through the coordinated, combined, operations of an electronic communications component and a label-printing component.

These coordinated operations will be more fully described later, but in general involve periodic automated electronic transmission of information entered into POD 70 by way of manual keyboard entry or other appropriate data entry methods including, for example, optical or electronic scanning, to Provider Server 30 coupled with the printing of specifically formatted labels for physical attachment to Bill of Laden documents associated with transported product. Automated electronic transmission of information from POD 70 to Provider Server 30 may be conducted by way of standard telephone line connections through a modem contained within POD 70 or by way of the Internet 10 directly or though client workstation 64 or by any other available means.

As will be more fully explained later, proof of delivery of product may be established in accordance with the present technology by physically attaching a specifically formatted label printed by POD 70 to a Bill of Laden associated with a product load, creating an image of the Bill of Laden with the attached POD 70 generated label attached and transmitting the created image to the Provider Server 30. The information encoded in the image of the specifically formatted label received at Provider Server 30 may be decoded and compared with information automatically transmitted to the Provider Server 30 as previously described.

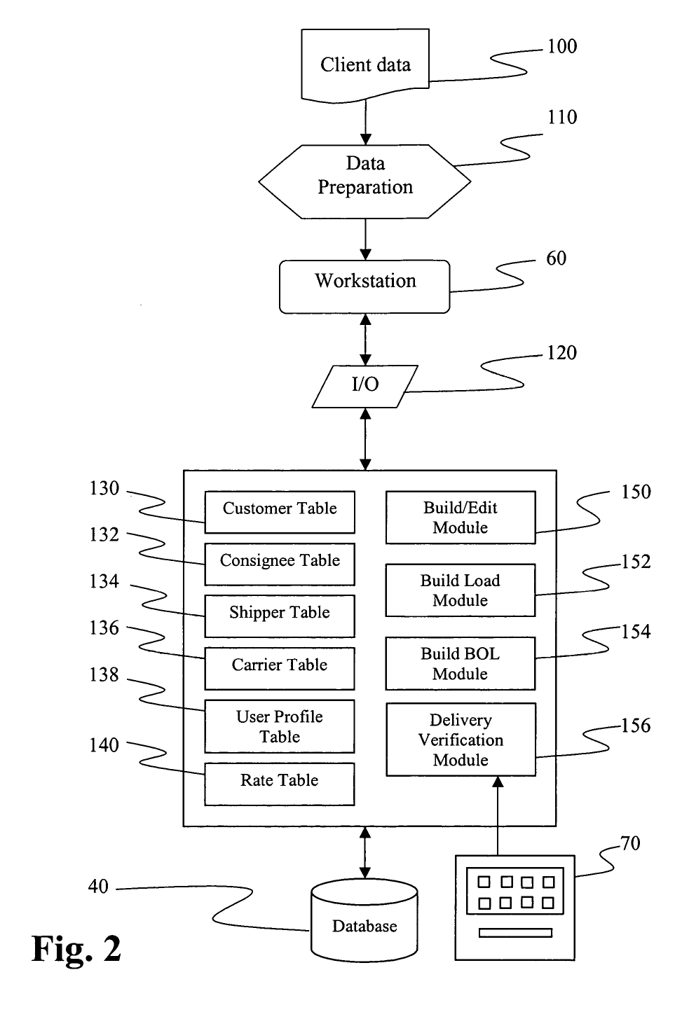

With reference now to FIG. 2, illustrated is an exemplary configuration of the operational configuration of the data entry and maintenance aspects of the Provider Server 30. As outlined in FIG. 2, client information 100 may be collected and compiled or prepared 110 in preparation for manual entry of the data at, for example, the provider workstation 60. Of course other workstations such as an agent workstation 62 (FIG. 1) possibly over a connection through a secured intranet 20 or via a LAN or WAN may be used for data entry purposes. Prepared information may be stored in database 40. In an exemplary implementation database 40, although not limited thereto, may comprise an “Open DataBase Connectivity” (ODBC) compliant database. ODBC corresponds to a standard database access method developed by Microsoft Corporation.

Generally information may be submitted by a client including the following: Client customer information, Shipper Identification, Receiver (consignee) Information, Item codes, UPC codes of the product being shipped and the quantities of each, Date(s) for pick up of freight, Date(s) for delivery of freight, Weight of total shipment, Total number of pieces in freight load, Total number of pallets in freight load, and Base rate for shipment based on rates agreed to by Provider (or agent) and client.

FIG. 2 diagrammatically illustrates the various subroutines or modules available within the software programming operating on the Provider Server 30 for inputting and manipulating data, selection of individual ones of which may be based on a menu selection. Build/Edit module 150 may be selected to start inputting the freight information supplied from the client as above enumerated. The user entering the supplied data will select from the various tables 130, 132, 134, 136, 138, and 140 to build a freight load. If appropriate data has not been previously entered in the tables the user can input the needed data in the tables based on the information provided from the client and then select them in the Build/Edit module 150. Once client data has been entered the user selects the Build BOL Module 152 to record bill of lading information and inputs the various item codes and/or UPC codes into the system that have been provided for the freight load from the client. Following entry of these data, the user may select the Build Load Module 152 from a menu listing and then select the base rate from the Rate Table 140 assigned to the client. At this point the load is available to bid out to the various carriers within the system. The user may then schedule pickup and delivery times with the shipper and consignee and input these data into the appropriate fields in the system. Once a carrier has accepted the rates offered the user chooses the carrier from the Carrier Table 136. The freight load is now ready to be tracked.

One aspect associated with tracking a freight load in accordance with the present technology corresponds to verification of delivery of the load to its intended destination. In this regard, an additional module, a Delivery Verification Module 156, is included within the software programming operating on the Provider Server 30. Data automatically transmitted from one or more PODs 70 is received at the Provider Server 30 and correlated with data previously stored in database 40 to provide verifiable proof of delivery of selected product.

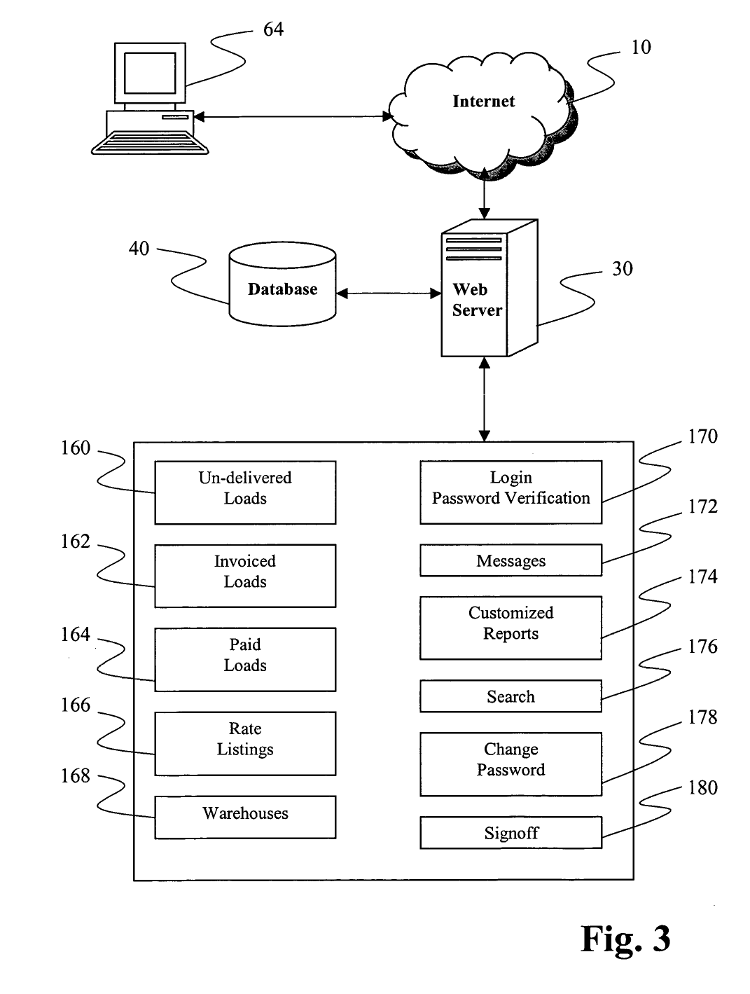

With reference now to FIG. 3, illustrated is an exemplary layout of an operational configuration of a client workstation's functional relationship within the collaborative logistics information exchange network. The client, by way of a client workstation 64 is able to view information from the client website and is able to obtain information regarding freight loads assigned to the provider. They can view the detail of the load and see the pickup and delivery dates and times for the load. Also the freight paperwork they have submitted to the provider is scanned into the system and is available to view as one of the miscellaneous documents associated with the load. As illustrated in FIG. 3, a number of subroutines or modules 160-180 are provided within the client website providing various load information including information regarding un-delivered loads 160, invoiced loads 162, paid loads 164, rate listings 166 and warehouses 168. In addition a search capability 174, customized report capability 172 and security functions including login/password verification 170, password maintenance 176 and a signoff subroutine 178 are provided. An additional capability available through client workstation 64 is a messages module 172 that gives clients the ability to pass instant messages to the provider and/or his agents. A special feature of the messages module 172 may permit a client to send a “broadcast” query to a provider and all agents online such that any one online may respond to such query.

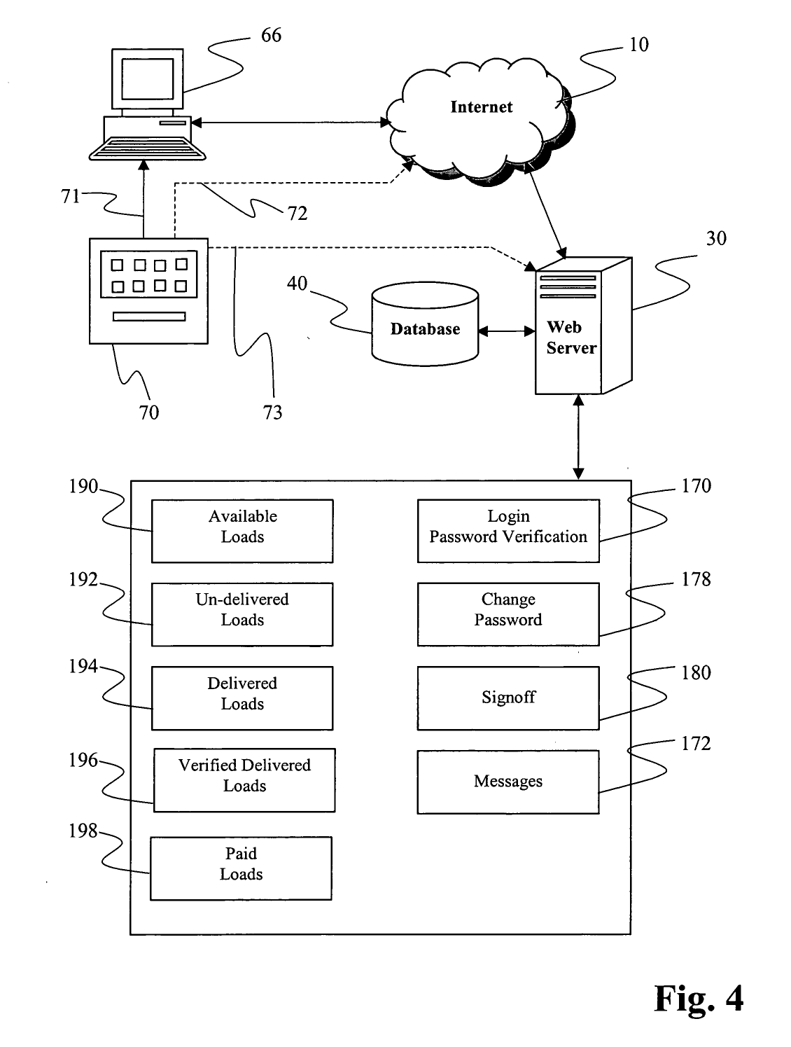

With reference to FIG. 4, illustrated is an exemplary layout of an operational configuration of a carrier workstation's functional relationship within the collaborative logistics information exchange network. A carrier, by way of carrier workstation 66 is able to view information from the carrier website and may obtain information regarding loads previously assigned to him as well as available loads to determine if there is a new load available that meets their needs. If such a load is found, the carrier can contact the provider or his agent and request to be assigned to the load. Carriers also have the capabilities to send an instant message using messages module 172 to the provider and may use that capability to ask to be assigned a particular freight load as well as to exchange other messages with the provider and/or his agents. Once an instant message is keyed into the system from either the client or the carrier a message bar is highlighted in the system to indicate to the provider and/or his agents that a message has been sent. Any of the provider associates (provider or his agents) can read the message and respond to the message and reply to the sending party.

As illustrated in FIG. 4, a number of subroutines or modules 190-198 are provided within the carrier website that mirror similar subroutines available on the client website. These subroutines provide various load information including information regarding available loads 190, un-delivered loads 192, delivered loads 194, verified delivered loads 196, and paid loads 198. In addition security functions including login/password verification 170, password maintenance 178 and a signoff subroutine 180 are available that are substantially equivalent subroutines as those provided for the client website. Security aspects associated with the login/password operation limit the information available to any one carrier to their own information to the exclusion of information related to other carriers who may also use the collaborative logistics information exchange network.

After a freight load has been picked up from the shipper the carrier calls the provider and relays information regarding time the carrier was loaded and if any fee's were charged during the loading process. This information is then keyed into the appropriate fields in the collaborative logistics information exchange system for that particular freight load. In accordance with the present technology, after the freight load has been delivered to the consignee, staff personnel at the consignee enter or cause to be entered data into POD 70 corresponding to information from the bill of laden associated with the delivered freight load. POD 70 is configured to encode and store the entered data and to print a specially encoded label that may then be physically affixed to the bill of laden. The stored data may be automatically transmitted to the Provider Server 30 as will be more fully explained later. An image of the bill if laden with the POD 70 generated label attached is then transmitted by facsimile to a specific fax number set up on the collaborative logistics information exchange system. Software associated with the Provider Server 30 may be configured to scan the facsimile image to, among other things, read the data encoded into the label printed by POD 70. By reading the data from the POD 70 generated label and associating such data with previously stored data, a reliable product delivery report may be generated. A provider associate may also access the system and attach information regarding the appropriate load as well as the appropriate data fields on the delivery time. The associates also have the capability to enter notes regarding the load. These notes are for the client to see if there were any issues with the load or other information that the provider may deem necessary for the client or carrier to see.

Once load information has been entered into the system the client can view details of the complete load, e.g. when it shipped, when it delivered, and any load notes associated with the load. With the documents that are attached with the load the client can bring up the documents to view as well as print the documents at their local printer. These documents may include the signed Bill of Lading with it's attached POD generated label that was faxed into the system at the provider site. Details regarding any particular load may be maintained within the collaborative logistics information exchange system for a predetermined period of time, for example, for one year, after which such older information may be moved to an archival location for more or less permanent storage or retrieval as necessary.

The client also has the capability from the client website (FIG. 3) to view other pertinent information such as Un-delivered Loads 160, Invoiced Loads 162, Paid Loads 164, and Rate Listings 166. Security aspects associated with the login/password operation limit the information available to any one client to their own information to the exclusion of information related to other clients who may also use the collaborative logistics information exchange network. At the client's request customized reports 174 can be made available on the site. From the client website the client can use the instant messaging system 172 to request rates that are not already on the rate listing table 166 for new freight loads or to inquire on existing freight loads from the said provider. A special feature of the present technology is that the instant messaging system is configured such that the Provider is automatically notified thereby if one of his clients accesses the collaborative logistics information exchange network.

The contracted carriers can also access the carrier website (FIG. 4) and once their logon and password are verified will be able to look at various information based on the menu selection on the site. The carrier is able to view the Available Loads 190 that displays all the available freight loads stored in the collaborative logistics information exchange system from all clients whose loads were entered into the system. If a carrier wishes to be assigned to one of the freight loads they can examine the stored information regarding the freight load and are provided the capability to send a message to the provider indicating their interest in being assigned to the load. The message comes into the provider and has the freight load number attached that the carrier was inquiring about. The carrier can also view all un-delivered loads 192 these are freight loads they have been assigned to by the provider. They can also view all delivered freight loads 194 and verified delivered loads 196. These are freight loads they have already delivered and the system will indicate when payment is expected for the freight load. The carrier can also view all paid freight loads 198 they have completed for the provider.

At this point is may be advantageous to review and expand on attributes of the POD 70. POD 70, in accordance with the present technology, provides a means whereby reliable proof of delivery of a product load may be established for payment and other purposes. POD 70 has been generally illustrated as a unitary device but it should be understood that the functionality of POD 70 might be provided separately as elements or combinations of elements. In an exemplary configuration POD 70 may be a unitary device that incorporates data entry features, data storage features, data transmission features, data processing features, and printing features.

In a basic configuration, POD 70 corresponds to a unitary device that may be placed at a product delivery facility. Upon delivery of product at the facility, data may be entered into POD 70 manually by way of an integrated keyboard. The use of a keyboard however is not a limitation of the present technology since other data entry methodologies may also or additionally be used. Other non-limiting examples of data entry methodologies include optical scan and RFID methodologies. Regardless of the data entry method(s) used, such data may be stored within a memory contained in or associated with POD 70. Stored data may be processed using know encryption methods and may be further processed and provided as data for a printing device that may correspond to an integral printer, i.e., a printer integral with the POD 70 or an external printer associated with POD 70. In either event, the printer may produce a label with encoded data printed thereon corresponding to processed information relating to the delivered load. As previously mentioned, the printed label is configured such that it may be affixed to the bill of laden accompanying the delivered product load.

Data entered and stored in the POD 70 may be automatically transmitted to the Provider Server 30. In particular, POD 70 may include a modem and/or some other communications device capable of transmitting stored data to the Provider Server 30. In an exemplary configuration, POD 70 may include a modem and POD 70 may be connected to an ordinary telephone line and configured such that an instruction is generated periodically by an onboard control processor to dial a specific telephone number associated with the Provider Server 30 and to download all of, for example, the current day's collected data. POD 70 may be associated with a particular serial number that may be associated with the transmitted data. Moreover, Provider Server 30 may be programmed to recognize not only the serial number of a particular POD 70 that may be calling in but also to associate the serial number transmitted with a caller identification number associated with the telephone line being used for the data transmission. In this way assurance may be had that a particular POD 70 is actually transmitting data from its assigned location.

As further assurance of reliability of the data transmitted, the data may be encrypted with an encryption code that may be change periodically so as to avoid duplication by unauthorized rogue PODs. Encryption codes may correspond to encoded versions of a serial number associated with a POD 70 as well as other data and may be changed daily or more or less often as desired to meet necessary or desire security levels. As previously mentioned, data may be transmitted from POD 70 by way of ordinary telephone lines as diagrammatically illustrated at 71 in FIG. 4, but such is not a limitation of the invention as data may also be transmitted from POD 70 directly over the Internet 10 via ethernet connection 72 or by direct connection 73 to Provider Server 30.

Regardless of the data transmission methodology used, data received by Provider Server 30 from an authorized POD 70 may be used as a comparison point for data received by way of facsimile transmission from a product delivery site. As the facsimile transmission should contain at least an image of the encoded label printed by the same POD 70 that transmits the same data independently to the Provider Server 30, verification of product delivery may be insured. Delivery verification may be further realized to be assured through the understanding that there should be a minimum time delay between receipt of data periodically transmitted by a particular POD 70 and corresponding facsimile transmitted data. Moreover it may be observed that since facsimile transmissions loose resolution upon retransmission, the logistics information system in accordance with the present technology will be able to discern whether any received facsimile transmission is legitimate based on the readability of the image of the POD printed label attached to the bill of laden.

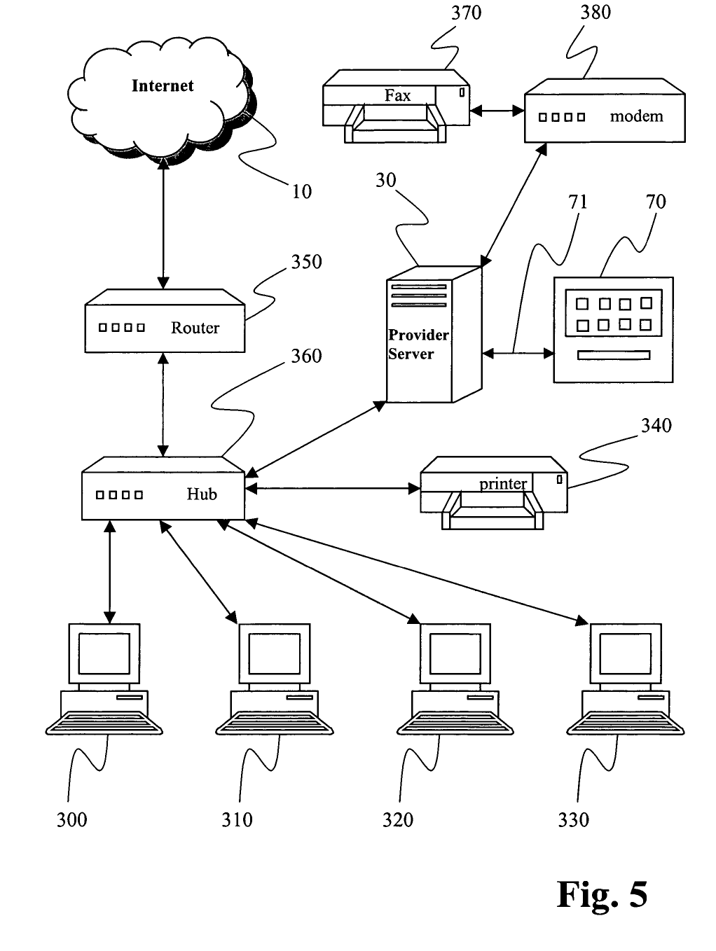

FIG. 5 is an exemplary diagrammatic representation of a local area network (LAN) or Intranet configuration for a Provider office. The illustrated system is capable of handling any number of workstations as represented by workstations 300-330 as well as other peripheral devices including in a non-limiting manner, printer 340, facsimile machine 370 and modem 380. Although only a single server 30 is illustrated, multiple servers may be employed depending on the workload at the Provider office. FIG. 5 also illustrates in a general manner the methodology whereby a connection to the Internet 10 is established using a secured fire walled router 350 and hub 360.

Proof of Delivery (POD) device 70 is illustratively shown connected to Provider Server 30 by way of connection line 71. POD 70, as will be recalled, is not physically located at the Provider's office, but rather may be located at delivery cites and communicates with the Provider Server 30 remotely via connection 71. Connection 71 may correspond to a telephone line connection whereby POD 70 may automatically call in periodically. Periodic calls may be made on a daily basis or on some other schedule as desired. The use of the word periodic should not be taken to suggest that a precise schedule must be followed, but rather that communications from POD 70 to Provider Server 30 occur from time to time as desired or necessary to ensure appropriate communication of product delivery data. It should also be borne in mind that although the previous discussion related to the use of telephone line communications, other data transmission methodologies may also be used including, but not limited to, direct connections, network connections and connections via the Internet.

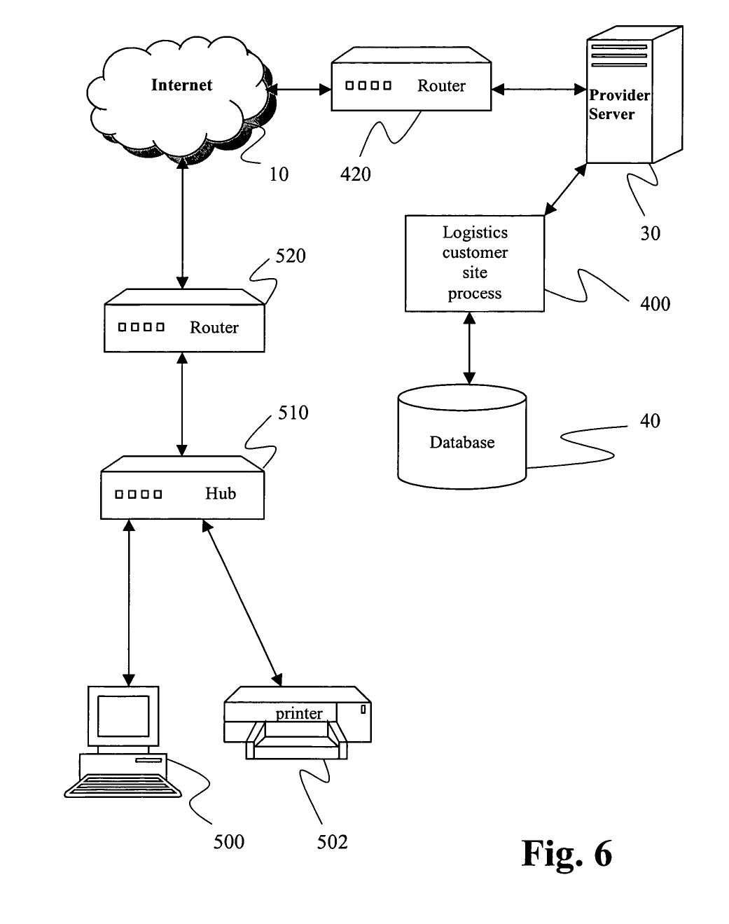

FIG. 6 is an exemplary diagrammatic representation illustrating the methodology for connecting a client and carrier through the Internet 10 by way of the Provider Server 30. The provider side of the connection includes a wide area network (WAN), local area network (LAN) or Intranet coupled to the Internet by way of router 420 that contains data stored in database 40 and supplies information and customer driven processes 400 in the form of various subroutines operating on Provider Server 30 to the Internet 10 side of the website for the clients and the carriers. Note that Provider customers correspond to at least clients and carriers. FIG. 6 illustrates only a single workstation 500 and printer 502 connected to the Internet 10 by way of hub 510 and router 520 but it should be clearly understood that such is representational only and that the system is capably of handling multiple users at multiple workstations each using their own printers and other peripherals at any one time.

While the present subject matter has been described in detail with respect to specific embodiments thereof, it will be appreciated that those skilled in the art, upon attaining an understanding of the foregoing may readily produce alterations to, variations of, and equivalents to such embodiments. Accordingly, the scope of the present disclosure is by way of example rather than by way of limitation, and the subject disclosure does not preclude inclusion of such modifications, variations and/or additions to the present subject matter as would be readily apparent to one of ordinary skill in the art.

What is claimed is:

1. A collaborative logistics information exchange system, comprising:
a provider server configured to provide information exchange and data processing capability;
a data storage device coupled to said provider server;
at least one provider workstation;
at least one client workstation;
at least one carrier workstation;
at least one proof of delivery device; and
communications means coupling said provider, client and carrier workstations and said proof of delivery device to said provider server,
wherein said provider server is configured to enable entry and retrieval of data via one or more of said provider, client and carrier workstations relating to the transportation of product from one location to another and wherein said proof of delivery device is configured to provide physical and electronic evidence of product delivery.

2. A collaborative logistics information exchange system as in claim 1, wherein said proof of delivery device comprises a printer and a data transmission means, whereby the printer provides physical evidence of product delivery and the data transmission device provides electronic evidence of product delivery.

3. A collaborative logistics information exchange system as in claim 2, wherein the physical evidence of product delivery comprises a data encoded label configured for attachment to selected paper associated with a delivered product and the electronic evidence of product delivery comprises data corresponding to data encoded in the label.

4. A collaborative logistics information exchange system as in claim 1, further comprising:
a security subroutine configured within the data processing capability of said provider server, said security routine selectively limiting access to information exchangeable between selected ones of client workstations and carrier workstations and said provider server.

5. A collaborative logistics information exchange system as in claim 4, further comprising:
a menu driven information entry and retrieval subroutine configured within the information exchange capability of said provider server, said menu driven information entry and retrieval subroutine providing selected levels of data entry and retrieval capability in dependence on whether an accessing workstation is a provider, client or carrier workstation.

6. A collaborative logistics information exchange system as in claim 5, wherein said communications means comprises a wide area network.

7. A collaborative logistics information exchange system as in claim 6, wherein said wide area network is the Internet.

8. A collaborative logistics information exchange system as in claim 1, wherein the provider server is configured to provide specialized instant messaging capability wherein an instant message initiated from selected workstations is automatically transmitted to a plurality of selected workstations, whereby a response to the instant message may be provided from any one of said plurality of selected workstations.

9. A method for collaboratively exchanging product delivery information, comprising the steps of:
establishing an information repository and processing center;
establishing a plurality of information entry and retrieval centers;
coupling said information repository and processing center and said plurality of information entry and retrieval centers together for information transfer;
providing selective information entry and retrieval capabilities for selected ones of the plurality of information entry and retrieval centers; and
providing physical and electronic evidence of product delivery.

10. The method of claim 9, further comprising the step of providing a specialized instant messaging capability between selected ones of the plurality of information entry and retrieval centers and selected pluralities of the plurality of information entry and retrieval centers.

11. The method of claim 10, further comprising the step of automatically transmitting a predetermined message to one or more selected of the plurality of information entry and retrieval centers upon occurrence of a predetermined activity at selected of said plurality of information entry and retrieval centers.

12. The method of claim 9 wherein the step of coupling comprises coupling said information repository and processing center and said plurality of information entry and retrieval centers together over a wide area network.

13. The method of claim 9 wherein the step of coupling comprises coupling said information repository and processing center and said plurality of information entry and retrieval centers together over the Internet.

14. The method of claim 9 wherein the step of providing physical and electronic evidence of product delivery comprises providing a printed label for attachment to selected papers associated with a delivered product and electronically transmitting data corresponding to data provided on the printed label.

15. A method of providing evidence of product delivery, comprising:
providing a product to be transported from a first location to a second location;
providing physical documentation regarding the product to be transported;
transporting the product together with the physical documentation from the first location to the second location;
printing a data encoded label with a printer located at the second location;
attaching the data encoded label to the physical documentation;
creating an image of the physical documentation after the step of attaching;
transmitting the image to a predetermined location; and
separately transmitting data corresponding to data encoded in the data encoded label to the predetermined location from a device at the second location,
whereby a comparison of data contained in the transmitted image and the separately transmitted data may establish evidence of product delivery from the first location to the second location.

16. The method of claim 15, wherein the step of printing and the step of separately transmitting are performed by a unitary device physically located at the second location.

17. The method of claim 16, wherein the step of separately transmitting data is performed periodically.

18. The method of claim 17, wherein the step of separately transmitting data comprises encoding the data corresponding to the data encoded label together with data identifying the source of the separately transmitted data using a predetermined algorithm and separately transmitting the encoded data to the predetermined location.

19. The method of claim 18, wherein the predetermined algorithm is periodically varied.
